(19) United States
(12) Patent Application Publication
(10) Pub. No.: US 2026/0327388 A1
(43) Pub. Date: Oct. 22, 2026

(54) CONTINUOUS FIBER REINFORCED THERMOPLASTIC MATERIALS AND OVER MOLDED ARTICLES INCLUDING SAME

(71) Applicant: AVIENT CORPORATION, Avon Lake, OH (US)

(72) Inventors: Daniel FLAGG, Avon Lake, OH (US); Brent DESILVA, Avon, OH (US); Jonathan SPIEGEL, Avon, OH (US)

(21) Appl. No.: 19/112,074

(22) PCT Filed: Sep. 14, 2023
(86) PCT No.: PCT/US2023/074219

§ 371 Date: Mar. 14, 2025

Related U.S. Application Data
(60) Provisional application No. 63/407,441, filed on Sep. 16, 2022.

(51) Int. Cl. C08J 5/24; B32B 27/08; B32B 27/32; C08J 5/12; C08L 23/14

(52) U.S. Cl. CPC C08J 5/24; B32B 27/08; B32B 27/32; C08J 5/121; C08L 23/14; B32B 2262/0261; B32B 2262/101; B32B 2262/106; C08J 2323/14; C08J 2423/00; C08L 2205/025

(57) ABSTRACT

Embodiments of the present disclosure are directed to continuous fiber reinforced thermoplastic materials including a polymer matrix and 50 wt % to 80 wt % of a plurality of continuous fibers, based on a total weight of the continuous fiber reinforced thermoplastic material. The polymer matrix comprises a polypropylene component and a polyolefin elastomer component.

### CLAIM OF PRIORITY

This application claims the benefit of U.S. Provisional Patent Application Ser. No. 63/407,441 bearing Attorney Docket Number 1202219 and filed on Sep. 16, 2022, which is hereby incorporated by reference in its entirety.

### TECHNICAL FIELD

Embodiments of the present disclosure are generally related to thermoplastic compositions, and are specifically related to continuous fiber reinforced thermoplastic materials having a relatively lower flexural modulus and a desired tensile strength and over molded articles formed therefrom.

### BACKGROUND

Continuous fiber reinforced thermoplastic materials may have desirable properties, such as tensile strength, for use in over molded articles. However, conventional continuous fiber reinforced thermoplastic materials may require preheating prior to placement in a mold. Such preheating may require specialized equipment, increase energy costs, or extend production times.

Accordingly, a continuous need exists for new and more cost-effective solutions for over molding continuous fiber reinforced thermoplastic materials while providing a desired tensile strength.

### SUMMARY

Embodiments of the present disclosure are directed to continuous fiber reinforced thermoplastic materials comprising a polymer matrix including a polypropylene component and a polyolefin elastomer component, which are relatively softer (i.e., reduced flexural modulus) to allow for bonding to a substrate without preheating and have a similar tensile strength as compared to a similar composition consisting of the polypropylene component and the continuous fibers.

According to one embodiment, a continuous fiber reinforced thermoplastic material is provided. The continuous fiber reinforced thermoplastic material comprises a polymer matrix and 50 wt % to 80 wt % of a plurality of continuous fibers, based on a total weight of the continuous fiber reinforced thermoplastic material. The polymer matrix comprises a polypropylene component and a polyolefin elastomer component.

According to another embodiment, a process for preparing an over molded article is provided. The process comprises contacting a continuous fiber reinforced thermoplastic material with a polymeric substrate in a mold and applying heat to bond the continuous fiber reinforced thermoplastic material to the polymeric substrate to form an over molded article.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a photograph of a top view comparative and exemplary over molded articles after being subject to three-point flex testing, according to one or more embodiments shown and described herein;

FIG. 2 is a photograph of a side view of the articles of FIG. 1;

FIG. 3 is a photograph of a comparative over molded article of FIG. 1;

FIG. 4 is a photograph of a comparative over molded article of FIG. 1; and

FIG. 5 is a photograph of an exemplary over molded article of FIG. 1.

### DETAILED DESCRIPTION

Reference will now be made in detail to various embodiments of continuous fiber reinforced thermoplastic materials (“CFR thermoplastic materials”), specifically CFR thermoplastic materials comprising a polymer matrix and 50 wt % to 80 wt % of a plurality of continuous fibers, based on a total weight of the CFR thermoplastic material. The polymer matrix comprises a polypropylene component and a polyolefin elastomer component.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “flexural modulus,” as described herein, refers to the ratio of stress to strain in flexural deformation as measured according to ASTM D790.

The term “tensile strength,” as described herein, refers to longitudinal tensile stress at break or the maximum stress that a material can withstand while stretching in a longitudinal direction before breaking as measured according to ASTM D638.

The term “similar tensile strength,” as described herein, refers to a tensile strength that is within 20% of the tensile strength of a similar composition consisting of the polypropylene component and the continuous fibers. The similar composition is lacking a polyolefin elastomer component.

The term “melt flow index,” as described herein, refers to the ability of a material's melt to flow under pressure as measured according to ASTM D1238 at the given temperature and given weight.

The term “tensile elongation at yield,” as described herein, refers to the ratio between the increased length and initial length at the yield point as measured according to ASTM D638 at 23° C. and a rate of strain of 0.85 mm/s.

The term “continuous fibers,” as described herein, refers to a fiber that spans all or substantially all of a dimension of the CFR thermoplastic material. The term “substantially all of a dimension,” as used herein, refers to greater than 75% of a dimension of the CFR thermoplastic material.

The term “average diameter,” as described herein, refers to an average of the diameters of each of the fibers in the plurality of continuous fibers.

The term “density,” as described herein, refers to the mass per unit volume of a material as measured according to ASTM D792 at 23° C.

The term “polyolefin elastomer (POE),” as described herein, as described herein, refers to a low crystalline (i.e., less than or equal to 25% crystalline) polymer prepared from olefin monomers.

The term “copolymer,” as described herein, refers to a polymer formed when two or more different monomers are linked in the same chain.

The term “block,” as described herein, refers to a portion of a macromolecule, comprising many constitutional units, that has at least one feature which is not present in the adjacent portions.

The terms “preheated” or “preheating,” as described herein, refer to heating the CFR thermoplastic material prior to the step of applying heat to bond the CFR thermoplastic material to a polymeric substrate. Generally, “preheating” means heating in an oven, with infrared heaters, or other conventional heating method prior to placing the CFR thermoplastic material in a mold or heating the CFR thermoplastic material in a mold using infrared heaters or other conventional heating methods prior to contacting and bonding the CFR thermoplastic material to the polymeric substrate.

As discussed hereinabove, CFR thermoplastic materials may have desirable properties, such as tensile strength, for use in over molded articles. However, conventional CFR thermoplastic materials may require preheating to allow the composition to conform to a mold shape and to create a strong interfacial bond between the composition and a substrate. Such preheating may require specialized equipment.

Disclosed herein are CFR thermoplastic materials, which mitigate the aforementioned problems. Specifically, the CFR thermoplastic materials disclosed herein comprise a polymer matrix and 50 wt % to 80 wt % of a plurality of continuous fibers, based on a total weight of the CFR thermoplastic material. The polymer matrix comprises a polypropylene component and a polyolefin elastomer component, which results in a CFR thermoplastic material that is relatively softer (i.e., reduced flexural modulus) to allow for bonding to a substrate without preheating and has a similar tensile strength as compared to a similar composition consisting of the polypropylene component and the continuous fibers.

The CFR thermoplastic materials disclosed herein may generally be described as comprising a polymer matrix and a plurality of continuous fibers. The plurality of continuous fibers are disposed within the polymer matrix and span all or substantially all of a dimension of the CFR thermoplastic material.

### Polymer Matrix

The CFR thermoplastic material may include a minimum amount of polymer matrix (e.g., greater than or equal to 20 wt %) to ensure there is an adequate amount of polymer matrix to sufficiently coat and bind the plurality of continuous fibers together to form the CFR thermoplastic material. The amount of the polymer matrix in the CFR thermoplastic material may be limited (e.g., less than or equal to 50 wt %) to ensure there is sufficient improvement of mechanical properties (e.g., tensile strength) in relation to the polymer being reinforced. Accordingly, in embodiments, the amount of the polymer matrix in the CFR thermoplastic material may be, based on a total weight of the CFR thermoplastic material, greater than or equal to 20 wt %, greater than or equal to 23 wt %, greater than or equal to 25 wt %, or even greater than or equal to 27 wt %. In embodiments, the amount of the polymer matrix in the CFR thermoplastic material may be, based on a total weight of the CFR thermoplastic material, less than or equal to 50 wt %, less than or equal to 45 wt %, less than or equal to 40 wt %, less than or equal to 35 wt %, less than or equal to 33 wt %, or even less than or equal to 30 wt %. In embodiments, the amount of the polymer matrix in the CFR thermoplastic material may be, based on a total weight of the CFR thermoplastic material, from 20 wt % to 50 wt %, from 20 wt % to 45 wt %, from 20 wt % to 40 wt %, from 20 wt % to 35 wt %, from 20 wt % to 33 wt %, from 20 wt % to 30 wt %, from 23 wt % to 50 wt %, from 23 wt % to 45 wt %, from 23 wt % to 40 wt %, from 23 wt % to 35 wt %, from 23 wt % to 33 wt %, from 23 wt % to 30 wt %, from 25 wt % to 50 wt %, from 25 wt % to 45 wt %, from 25 wt % to 40 wt %, from 25 wt % to 35 wt %, from 25 wt % to 33 wt %, from 25 wt % to 30 wt %, from 27 wt % to 50 wt %, from 27 wt % to 45 wt %, from 27 wt % to 40 wt %, from 27 wt % to 35 wt %, from 27 wt % to 33 wt %, or even from 27 wt % to 30 wt %, or any and all subranges formed from any of these endpoints.

The polymer matrix of the CFR thermoplastic materials comprises a polypropylene component and a polyolefin elastomer component. The combination of a polypropylene component and a polyolefin elastomer component in a CFR thermoplastic material produces a softer composition with similar tensile strength as compared to a similar composition consisting of the polypropylene component and the continuous fibers. The polypropylene component imparts tensile strength and allows for bonding to a substrate. The polyolefin elastomer component reduces the melting point of the CFR thermoplastic material, making it softer (i.e., reduced flexural modulus) and allowing for over molding without preheating the CFR thermoplastic material.

### Polypropylene Component

In embodiments, the polypropylene component may comprise a polypropylene polymer. In embodiments, the polypropylene component may comprise at least one polypropylene polymer selected from the group consisting of polypropylene homopolymer, polypropylene impact copolymer, and polypropylene random copolymer. In embodiments, the polypropylene polymer may include at least 85% propylene monomeric units, based on a total of monomeric units in the polypropylene polymer.

In embodiments, the polypropylene polymer may have a melt flow index greater than or equal to 15 g/10 min, as measured at a temperature of 230° C. at a load of 2.16 kg. In embodiments, the polypropylene polymer may have a melt flow index greater than or equal to 15 g/10 min, greater than or equal to 30 g/10 min, greater than or equal to 50 g/10 min, or even greater than or equal to 70 g/10 min, as measured at a temperature of 230° C. at a load of 2.16 kg. In embodiments, the polypropylene polymer may have a melt flow index less than or equal to 150 g/10 min, less than or equal to 125 g/10 min, or even less than or equal to 100 g/10 min, as measured at a temperature of 230° C. at a load of 2.16 kg. In embodiments, the polypropylene polymer may have a melt flow index greater from 15 g/10 min to 150 g/10 min, from 15 g/10 min to 125 g/10 min, from 15 g/10 min to 100 g/10 min, 30 g/10 min to 150 g/10 min, from 30 g/10 min to 125 g/10 min, from 30 g/10 min to 100 g/10 min, from 50 g/10 min to 150 g/10 min, from 50 g/10 min to 125 g/10 min, from 50 g/10 min to 100 g/10 min, from 70 g/10 min to 150 g/10 min, from 70 g/10 min to 125 g/10 min, or even from 70 g/10 min to 100 g/10 min, or any and all subranges formed from any of these endpoints, as measured at a temperature of 230° C. at a load of 2.16 kg.

In embodiments, the polypropylene polymer may have a tensile strength greater than or equal to 20 MPa. In embodiments, the polypropylene polymer may have a tensile strength greater than or equal to 20 MPa, greater than or equal to 22 MPa, greater than or equal to 24 MPa, or even greater than or equal to 26 MPa. In embodiments, the polypropylene polymer may have a tensile strength less than or equal to 40 MPa, less than or equal to 35 MPa, or even less than or equal to 30 MPa. In embodiments, the polypropylene polymer may have a tensile strength from 20 MPa to 40 MPa, from 20 MPa to 35 MPa, from 20 MPa to 30 MPa, from 22 MPa to 40 MPa, from 22 MPa to 35 MPa, from 22 MPa to 30 MPa, from 24 MPa to 40 MPa, from 24 MPa to 35 MPa, from 24 MPa to 30 MPa, from 26 MPa to 40 MPa, from 26 MPa to 35 MPa, or even from 26 MPa to 30 MPa, or any and all subranges formed from any of these endpoints.

In embodiments, the polypropylene polymer may have a tensile elongation at yield greater than or equal to 2%. In embodiments, the polypropylene polymer may have a tensile elongation at yield greater than or equal to 2%, greater than or equal to 3%, or even greater than or equal to 4%. In embodiments, the polypropylene polymer may have a tensile elongation at yield less than or equal to 20%, less than or equal to 15%, less than or equal to 10%, or even less than or equal to 5%. In embodiments, the polypropylene polymer may have a tensile elongation at yield from 2% to 20%, from 2% to 15%, from 2% to 10%, from 2% to 5%, from 3% to 20%, from 3% to 15%, from 3% to 10%, from 3% to 5%, from 4% to 20%, from 4% to 15%, from 4% to 10%, or even from 4% to 5%, or any and all subranges formed from any of these endpoints.

In embodiments, the polypropylene polymer may have a flexural modulus greater than or equal to 1000 MPa or even greater than or equal to 1250 MPa. In embodiments, the polypropylene polymer may have a flexural modulus less than or equal to 1750 MPa or even less than or equal to 1500 MPa. In embodiments, the polypropylene polymer may have a flexural modulus from 1000 MPa to 1750 MPa, from 1000 MPa to 1500 MPa, from 1250 MPa to 1750 MPa, or even from 1250 MPa to 1500 MPa, or any and all subranges formed from any of these endpoints.

The polymer matrix may include a minimum amount of polypropylene component (e.g., greater than or equal 20 wt %) to achieve a desired tensile strength and ensure bonding to a substrate. The amount of polypropylene component in the polymer matrix may be limited (e.g., less than or equal to 95 wt %) to ensure that a relatively softer composition is achieved. Accordingly, in embodiments, the polymer matrix may comprise, based on a total weight of the polymer matrix, 20 wt % to 95 wt % of the polypropylene component. In embodiments, the amount of the polypropylene component in the polymer matrix may be, based on a total weight of the polymer matrix, greater than or equal to 20 wt %, greater than or equal to 30 wt %, greater than or equal to 40 wt %, greater than or equal to 50 wt %, greater than or equal to 60 wt %, greater than or equal to 70 wt %, or even greater than or equal to 80 wt % In embodiments, the amount of the polypropylene component in the polymer matrix may be, based on a total weight of the polymer matrix, less than or equal to 95 wt %, less than or equal to 90 wt %, less than or equal to 85 wt %, less than or equal to 80 wt %, less than or equal to 75 wt %, or even less than or equal to 70 wt %. In embodiments, the amount of the polypropylene component in the polymer matrix may be, based on a total weight of the polymer matrix, from 20 wt % to 95 wt %, from 20 wt % to 90 wt %, from 20 wt % to 85 wt %, from 20 wt % to 80 wt %, from 20 wt % to 75 wt %, from 20 wt % to 70 wt %, from 30 wt % to 95 wt %, from 30 wt % to 90 wt %, from 30 wt % to 85 wt %, from 30 wt % to 80 wt %, from 30 wt % to 75 wt %, from 30 wt % to 70 wt %, from 40 wt % to 95 wt %, from 40 wt % to 90 wt %, from 40 wt % to 85 wt %, from 40 wt % to 80 wt %, from 40 wt % to 75 wt %, from 40 wt % to 70 wt %, from 50 wt % to 95 wt %, from 50 wt % to 90 wt %, from 50 wt % to 85 wt %, from 50 wt % to 80 wt %, from 50 wt % to 75 wt %, from 50 wt % to 70 wt %, from 60 wt % to 95 wt %, from 60 wt % to 90 wt %, from 60 wt % to 85 wt %, from 60 wt % to 80 wt %, from 60 wt % to 75 wt %, from 60 wt % to 70 wt %, from 70 wt % to 95 wt %, from 70 wt % to 90 wt %, from 70 wt % to 85 wt %, from 70 wt % to 80 wt %, from 70 wt % to 75 wt %, from 80 wt % to 95 wt %, from 80 wt % to 90 wt %, or even from 80 wt % to 85 wt %, or any and all subranges formed from any of these endpoints.

In embodiments, the amount of the polypropylene component in the CFR thermoplastic material may be, based on a total weight of the CFR thermoplastic material, greater than or equal to 10 wt %, greater than or equal to 15 wt %, or even greater than or equal to 20 wt %. In embodiments, the amount of the polypropylene component in the CFR thermoplastic material may be, based on a total weight of the CFR thermoplastic material, less than or equal to 40 wt %, less than or equal to 35 wt %, or even less than or equal to 30 wt %. In embodiments, the amount of the polypropylene component in the CFR thermoplastic material may be, based on a total weight of the CFR thermoplastic material, from 10 wt % to 40 wt %, from 10 wt % to 35 wt %, from 10 wt % to 30 wt %, from 15 wt % to 40 wt %, from 15 wt % to 35 wt %, from 15 wt % to 30 wt %, from 20 wt % to 40 wt %, from 20 wt % to 35 wt %, or even from 20 wt % to 30 wt %, or any all subranges formed from any of these endpoints.

Suitable commercial embodiments of the polypropylene component are available from Braskem, such as polypropylene impact copolymer grade C758-80NA.

### Polyolefin Elastomer Component

In embodiments, the polyolefin elastomer component may comprise a polyolefin elastomer. In embodiments, the polyolefin elastomer component may comprise at least one polyolefin elastomer selected from the group consisting of ethylene-butene random copolymer, ethylene-octene random copolymer, and ethylene-octene block copolymer.

In embodiments, the polyolefin elastomer may be characterized by a melt flow index measured at a temperature of 190° C. at a load of 2.16 kg. In embodiments, the polyolefin elastomer may have a melt flow index from 5 g/10 min to 30 g/10 min, as measured at a temperature of 190° C. at a load of 2.16 kg. In embodiments, the polyolefin elastomer may have a melt flow index greater than or equal to 5 g/10 min or even greater than or equal to 10 g/10 min, as measured at a temperature of 190° C. at a load of 2.16 kg. In embodiments, the polyolefin elastomer may have a melt flow index less than or equal to 30 g/10 min, less than or equal to 25 g/10 min, or even less than or equal to 20 g/10 min, as measured at a temperature of 190° C. at a load of 2.16 kg. In embodiments, the polyolefin elastomer may have a melt flow index from 5 g/10 min to 30 g/10 min, from 5 g/10 min to 25 g/10 min, from 5 g/10 min to 20 g/10 min, from 10 g/10 min to 30 g/10 min, from 10 g/10 min to 25 g/10 min, or even from 10 g/10 min to 20 g/10 min, or any and all subranges formed from any of these endpoints.

In embodiments, the polyolefin elastomer may be characterized by the density of the polyolefin elastomer. In embodiments, the polyolefin elastomer may have a density from 0.83 g/cm³ to 0.91 g/cm³. In embodiments, the polyolefin elastomer may have a density greater than or equal to 0.83 g/cm³, greater than or equal to 0.84 g/cm³, greater than or equal to 0.85 g/cm³, or even greater than or equal to 0.86 g/cm³. In embodiments, the polyolefin elastomer may have a density less than or equal to 0.91 g/cm³, less than or equal to 0.90 g/cm³, less than or equal to 0.89 g/cm³, or even less than or equal to 0.88 g/cm³. In embodiments, the polyolefin elastomer may have a density from 0.83 g/cm³ to 0.91 g/cm³, from 0.83 g/cm³ to 0.90 g/cm³, from 0.83 g/cm³ to 0.89 g/cm³, from 0.83 g/cm³ to 0.88 g/cm³, from 0.84 g/cm³ to 0.91 g/cm³, from 0.84 g/cm³ to 0.90 g/cm³, from 0.84 g/cm³ to 0.89 g/cm³, from 0.84 g/cm³ to 0.88 g/cm³, from 0.85 g/cm³ to 0.91 g/cm³, from 0.85 g/cm³ to 0.90 g/cm³, from 0.85 g/cm³ to 0.89 g/cm³, from 0.85 g/cm³ to 0.88 g/cm³, from 0.86 g/cm³ to 0.91 g/cm³, from 0.86 g/cm³ to 0.90 g/cm³, from 0.86 g/cm³ to 0.89 g/cm³, or even from 0.86 g/cm³ to 0.88 g/cm³, or any and all subranges formed from any of these endpoints.

The polymer matrix may include a minimum amount (e.g., greater than or equal to 5 wt %) of the polyolefin elastomer component to ensure a reduced flexural modulus and allow for over molding without preheating the CFR thermoplastic material. The amount of the polyolefin elastomer component may be limited (e.g., less than or equal to 80 wt %) to ensure a desired tensile strength is achieved. Accordingly, in embodiments, the polymer matrix may comprise, based on a total weight of the polymer matrix, 5 wt % to 80 wt % of the polyolefin elastomer component. In embodiments, the amount of the polyolefin elastomer component in the polymer matrix may be, based on a total weight of the polymer matrix, greater than or equal to 5 wt %, greater than or equal to 10 wt %, greater than or equal to 15 wt %, greater than or equal to 20 wt %, greater than or equal to 25 wt %, or even greater than or equal to 30 wt %. In embodiments, the amount of the polyolefin elastomer component in the polymer matrix may be, based on a total weight of the polymer matrix, less than or equal to 80 wt %, less than or equal to 70 wt %, less than or equal to 60 wt %, less than or equal to 50 wt %, less than or equal to 40 wt %, less than or equal to 30 wt %, or even less than or equal to 20 wt %. In embodiments, the amount of the polyolefin elastomer component in the polymer matrix may be, based on a total weight of the polymer matrix, from 5 wt % to 80 wt %, from 5 wt % to 70 wt %, from 5 wt % to 60 wt %, from 5 wt % to 50 wt %, from 5 wt % to 40 wt %, from 5 wt % to 30 wt %, from 5 wt % to 20 wt %, from 10 wt % to 80 wt %, from 10 wt % to 70 wt %, from 10 wt % to 60 wt %, from 10 wt % to 50 wt %, from 10 wt % to 40 wt %, from 10 wt % to 30 wt %, from 10 wt % to 20 wt %, from 15 wt % to 80 wt %, from 15 wt % to 70 wt %, from 15 wt % to 60 wt %, from 15 wt % to 50 wt %, from 15 wt % to 40 wt %, from 15 wt % to 30 wt %, from 15 wt % to 20 wt %, from 20 wt % to 80 wt %, from 20 wt % to 70 wt %, from 20 wt % to 60 wt %, from 20 wt % to 50 wt %, from 20 wt % to 40 wt %, from 20 wt % to 30 wt %, from 25 wt % to 80 wt %, from 25 wt % to 70 wt %, from 25 wt % to 60 wt %, from 25 wt % to 50 wt %, from 25 wt % to 40 wt %, from 25 wt % to 30 wt %, from 30 wt % to 80 wt %, from 30 wt % to 70 wt %, from 30 wt % to 60 wt %, from 30 wt % to 50 wt %, or even from 30 wt % to 40 wt %, or any and all subranges formed from any of these endpoints.

In embodiments, the amount of the polyolefin elastomer component in the CFR thermoplastic material may be, based on a total weight of the CFR thermoplastic material, greater than or equal to 1 wt %, greater than or equal to 3 wt %, or even greater than or equal to 5 wt %. In embodiments, the amount of the polyolefin elastomer component in the CFR thermoplastic material may be, based on a total weight of the CFR thermoplastic material, less than or equal to 20 wt %, less than or equal to 15 wt %, or even less than or equal to 10 wt %. In embodiments, the amount of the polyolefin elastomer component in the CFR thermoplastic material may be, based on a total weight of the CFR thermoplastic material, from 1 wt % to 20 wt %, from 1 wt % to 15 wt %, from 1 wt % to 10 wt %, from 3 wt % to 20 wt %, from 3 wt % to 15 wt %, from 3 wt % to 10 wt %, from 5 wt % to 20 wt %, from 5 wt % to 15 wt %, or even from 5 wt % to 10 wt %, or any and all subranges formed from any of these endpoints.

Suitable commercial embodiments of the polyolefin elastomer component are available under the INFUSE brand from Dow, such as olefin block copolymer grade 9817.

### Plurality of Continuous Fibers

In embodiments, the plurality of continuous fibers may span all or substantially all of a dimension of the CFR composition. For example, in embodiments, the plurality of continuous fibers may span all or substantially all of the length of the CFR composition. In embodiments, each of the continuous fibers in the plurality of continuous fibers may have a length and the lengths of the continuous fibers in the plurality of continuous fibers may be substantially parallel. For example, in embodiments, the lengths of the continuous fibers may extend along and parallel to the length of the CFR composition.

In embodiments, the plurality of continuous fibers may comprise at least one of glass fibers, aramid fibers, basalt fibers, and carbon fibers.

In embodiments, the plurality of continuous fibers may have an average diameter from 10 μm to 30 μm to ensure a desired tensile strength is achieved. In embodiments, the plurality of fibers may have an average dimeter greater than or equal to 10 μm or even greater than or equal to 15 μm. In embodiments, the plurality of fibers may have an average diameter less than or equal to 30 μm or even less than or equal to 25 μm. In embodiments, the plurality of fibers may have an average diameter from 10 μm to 30 μm, from 10 μm to 25 μm, from 15 μm to 30 μm, or even from 15 μm to 25 μm, or any and all subranges formed from any of these endpoints.

In embodiments, the plurality of continuous fibers may have an average linear mass density from 4400 TEX to 276 TEX. In embodiments, the plurality of continuous fibers may have an average linear mass density less than or equal to 4400 TEX, less than or equal to 4000 TEX, less than or equal to 3600 TEX, less than or equal to 3200 TEX, less than or equal to 2800 TEX, less than or equal to 2400 TEX, less than or equal to 2000 TEX, or even less than or equal to 1600 TEX. In embodiments, the plurality of continuous fibers may have an average linear mass density greater than or equal to 276 TEX, greater than or equal to 400 TEX, greater than or equal to 600 TEX, greater than or equal to 800 TEX, or even greater than or equal to 1000 TEX. In embodiments, the plurality of continuous fibers may have an average linear mass density from 4400 TEX to 276 TEX, from 4400 TEX to 400 TEX, from 4400 TEX to 600 TEX, from 4400 TEX to 800 TEX, from 4400 TEX to 1000 TEX, from 4000 TEX to 276 TEX, from 4000 TEX to 400 TEX, from 4000 TEX to 600 TEX, from 4000 TEX to 800 TEX, from 4000 TEX to 1000 TEX, from 3600 TEX to 276 TEX, from 3600 TEX to 400 TEX, from 3600 TEX to 600 TEX, from 3600 TEX to 800 TEX, from 3600 TEX to 1000 TEX, from 3200 TEX to 276 TEX, from 3200 TEX to 400 TEX, from 3200 TEX to 600 TEX, from 3200 TEX to 800 TEX, from 3200 TEX to 1000 TEX, from 2800 TEX to 276 TEX, from 2800 TEX to 400 TEX, from 2800 TEX to 600 TEX, from 2800 TEX to 800 TEX, from 2800 TEX to 1000 TEX, from 2400 TEX to 276 TEX, from 2400 TEX to 400 TEX, from 2400 TEX to 600 TEX, from 2400 TEX to 800 TEX, from 2400 TEX to 1000 TEX, from 2000 TEX to 276 TEX, from 2000 TEX to 400 TEX, from 2000 TEX to 600 TEX, from 2000 TEX to 800 TEX, from 2000 TEX to 1000 TEX, from 1600 TEX to 276 TEX, from 1600 TEX to 400 TEX, from 1600 TEX to 600 TEX, from 1600 TEX to 800 TEX, or even from 1600 TEX to 1000 TEX, or any and all subranges formed from any of these endpoints.

In embodiments, the plurality of continuous fibers may be in a tow, yarn, roving, or woven mat.

The CFR thermoplastic material may include a minimum amount of the plurality of continuous fibers (e.g., greater than or equal to 50 wt %) to ensure there is sufficient improvement of mechanical properties (e.g., tensile strength) in relation to the polymer being reinforced. The amount of the plurality of continuous fibers in the CFR thermoplastic material may be limited (e.g., less than or equal to 80 wt %) to ensure there is an adequate amount of polymer matrix to sufficiently coat and bind the plurality of continuous fibers together to form the CFR thermoplastic material. Accordingly, in embodiments, the CFR thermoplastic material may comprise, based on a total weight of the CFR thermoplastic material, from 50 wt % to 80 wt % of the plurality of continuous fibers. In embodiments, the amount of the plurality of continuous fibers in the CFR thermoplastic material may be, based on a total weight of the CFR thermoplastic material, greater than or equal to 50 wt % or even greater than or equal to 60 wt %. In embodiments, the amount of the plurality of continuous fibers in the CFR thermoplastic material may be, based on a total weight of the CFR thermoplastic material, less than or equal to 80 wt % or even less than or equal to 70 wt %. In embodiments, the amount of the plurality of continuous fibers in the CFR thermoplastic material may be, based on a total weight of the CFR thermoplastic material, from 50 wt % to 80 wt %, from 50 wt % to 70 wt %, from 60 wt % to 80 wt %, or even from 60 wt %, to 70 wt %, or any and all subranges formed from any of these endpoints.

### CFR Thermoplastic Material

As described herein, the CFR thermoplastic materials may have polymer matrix comprising a polypropylene component and a polyolefin elastomer component, which results in a CFR thermoplastic material that is relatively softer (i.e., reduced flexural modulus) to allow for bonding to a substrate without preheating and has a similar tensile strength as compared to a similar composition consisting of the polypropylene component and the continuous fibers. In embodiments, the CFR composition may have a tensile strength that is within 20%, within 17%, within 15%, or even within 13% of the tensile strength of a similar composition consisting of the polypropylene component and the continuous fibers.

In embodiments, the CFR thermoplastic material may have a flexural modulus greater than or equal to 20 GPa, greater than or equal to 23 GPa, or even greater than or equal to 25 GPa. In embodiments, the CFR thermoplastic material may have a flexural modulus less than or equal to 40 GPa, less than or equal to 35 GPa, or even less than or equal to 30 GPa. In embodiments, the CFR thermoplastic material may have a flexural modulus from 20 GPa to 40 GPa, from 20 GPa to 35 GPa, from 20 GPa to 30 GPa, from 23 GPa to 40 GPa, from 23 GPa to 35 GPa, from 23 GPa to 30 GPa, from 25 GPa to 40 GPa, from 25 GPa to 35 GPa, or even from 25 GPa to 30 GPa, or any and all subranges formed from any of these endpoints.

In embodiments, the CFR thermoplastic material may be a tape, a sheet, panel, rod, a tube or a panel. As indicated above, the CFR thermoplastic material a plurality of continuous fibers that are substantially parallel. In embodiments, the CFR thermoplastic material may be a unidirectional tape. In embodiments, the CFR thermoplastic material may be a layer in a laminate.

### Additives

In embodiments, the CFR thermoplastic material may further comprise an additive. In embodiments, the additive may comprise antioxidants, stabilizers, adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof. In embodiments, the additives may be present in the polymer matrix.

### Processing

In embodiments, the CFR thermoplastic material described herein may be made with a batch process or continuous process. In embodiments, the polypropylene component and the polyolefin elastomer component of the polymer matrix may be blended during the batch process or continuous process.

In embodiments, the components of the polymer matrix, including the polypropylene component, the polyolefin elastomer component may be added to an extruder (e.g., 27 MM Leistritz Twin Extruder (L/D 60)) and blended. In embodiments, the blending (e.g., in the barrel of the extruder) may be carried out at a temperature in the range of 150° C. to 270° C. In embodiments, the polypropylene component and the polyolefin elastomer component of the polymer matrix may be compounded (i.e., blended together) in the extruder.

Blending (also known as compounding) devices are well known to those skilled in the art and generally include means of feeding, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the CFR thermoplastic material may be formed by pultrusion. In a pultrusion process, a plurality of continuous fibers are pulled through a bath of the polymeric matrix or through an injection chamber where the polymeric matrix is injected into the chamber such that the polymer matrix impregnated the plurality of continuous fibers. Pultrusion allows for the formation of tapes, sheets, or other extruded shapes of continuous fibers impregenated with the polymer matrix.

### Over Molded Article

In embodiments, an over molded article may comprise the CFR thermoplastic material described herein bonded to a polymeric substrate. In embodiments, the polymeric substrate may be a fiber reinforced polypropylene substrate.

In embodiments, a process for preparing an over molded article may comprise contacting a CFR thermoplastic material as described herein to a polymeric substrate to form an over molded article. In embodiments, the mold may be an injection mold or a compression mold.

As explained herein, the polymer matrix of the CFR thermoplastic material comprises a polypropylene component and a polyolefin elastomer component, which results in a CFR thermoplastic material that is relatively softer (i.e., reduced flexural modulus) to allow for bonding to a substrate without preheating. Accordingly, in embodiments, the CFR thermoplastic material may not be preheated prior to the step of applying heat to bond the CFR thermoplastic material to the polymeric substrate.

The over molding process may include open injection molding, direct long fiber composite (DLFT) compression molding, or glass matter thermoplastic (GMT) compression molding. In embodiment, the over molded article may comprise a generally rectangular cross-section. A person having ordinary skill in the art would appreciate that other geometries may be manufactured.

### Examples

Table 1 below shows sources of ingredients used to form Comparative Composition CC1 and Example Compositions EC1 and EC2.

TABLE 1

| Ingredients | Brand | Source |
|---|---|---|
| polypropylene component | C758-80NA | Braskem |
| (polypropylene impact copolymer) | | |
| polyolefin elastomer component | INFUSE 9817 | Dow |
| (olefin block copolymer) | | |
| colorant | REMAFIN Black | Avient |
| silane coupling agent | PA BOND 700 | Mitsui Plastics, Inc |
| continuous fibers | PERFORMAX SE4849 | Owens Corning |
| | (1100 TEX) | |

Table 2 below shows the formulations (in wt %, based on a total weight of the polymer matrix and based on a total weight of the CFR thermoplastic materials) used to form and the certain properties of Comparative Composition CC1 and Example Compositions EC1 and EC2. To form Comparative Composition CC1 and Example Compositions EC1 and EC2, the components were melt blended to form articles having a thickness of 0.20 mm, 0.20 mm, and 0.22 mm, respectively.

TABLE 2

| | | |
|---|---|---|
| CC1 | EC1 | EC2 |

Polymer Matrix

| | | | |
|---|---|---|---|
| C758-80NA | 96.50 | 87.50 | 67.50 |
| INFUSE 9817 | 0 | 10.00 | 29.00 |
| REMAFIN Black | 1.00 | 0 | 1.00 |
| PA BOND 700 | 2.50 | 2.50 | 2.50 |
| TOTAL | 100.00 | 100.00 | 100.00 |

CFR thermoplastic material

| | | | |
|---|---|---|---|
| C758-80NA | 28.95 | 26.25 | 20.25 |
| INFUSE 9817 | 0 | 3.00 | 8.70 |
| REMAFIN Black | 0.30 | 00 | 0.30 |
| PA BOND 700 | 0.75 | 0.75 | 0.75 |
| PERFORMAX SE4849 | 70.00 | 70.00 | 70.00 |
| TOTAL | 100.00 | 100.00 | 100.00 |
| Tensile strength (MPa) | 855 | 869 | 745 |
| Tensile modulus relative | — | 1.6 | −12.9 |
| to CC1 (%) | | | |
| Flexural modulus (GPa) | 31 | 30 | 28 |

As shown in Table 2, Example Compositions EC1 and EC2, compositions including C758-80NA (polypropylene) and INFUSE 9817 (polyolefin elastomer), had a lower flexural modulus and a similar tensile strength as compared to Comparative Example CC1, a composition including C758-80NA and lacking INFUSE 9817. As indicated by Comparative Example CC1 and Example Compositions EC1 and EC2, a CFR thermoplastic material including a polymer matrix having a polypropylene component and a polyolefin elastomer component results in a softer composition with a similar tensile strength as compared to a similar composition consisting of the polypropylene component and lacking the polyolefin elastomer component.

Table 3 below shows compositions and the certain properties of Comparative Over Molded Articles CA1 and CA2 and Example Over Molded Articles EA1 and EA2 after being subjected to three-point flex testing at an 8 inch span according to ASTM D790. To prepare the over molded articles, face sheets of the CFR thermoplastic materials were applied to opposing surfaces of an open injection molding tool. For Comparative Over Molded Article CA2, which involved preheating, the face sheets were preheated prior to insertion in the molding tool. After any applicable preheating and insertion in the tool, the tool was closed and the injection process was initiated to fill the void between the two face sheets and form the rectangular polymeric substrate.

TABLE 3

| | CA1 | CA2 | EA1 | EA2 |
|---|---|---|---|---|
| Compositions | CC1 | CC1 | EC1 | EC2 |
| Preheating | No | Yes | No | No |
| Maximum load (kg) | 62 | 118 | 90 | 93 |
| Maximum deflection (cm) | 0.7 | 2.7 | 4.3 | 4.5 |
| Flexural modulus (GPa) | 11.6 | 11.7 | 11.5 | 11.3 |

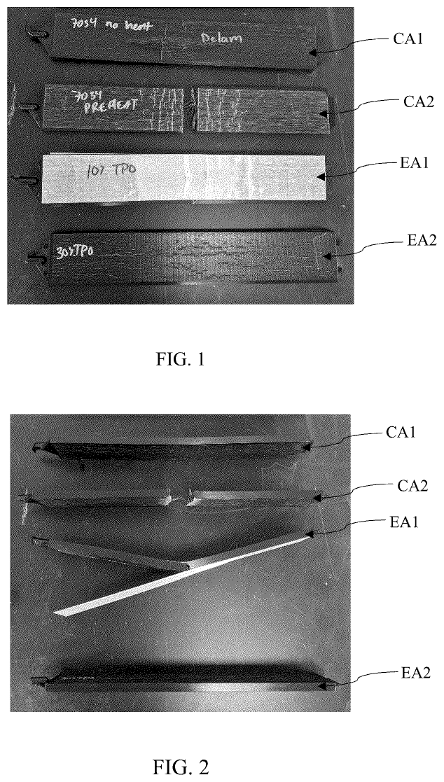

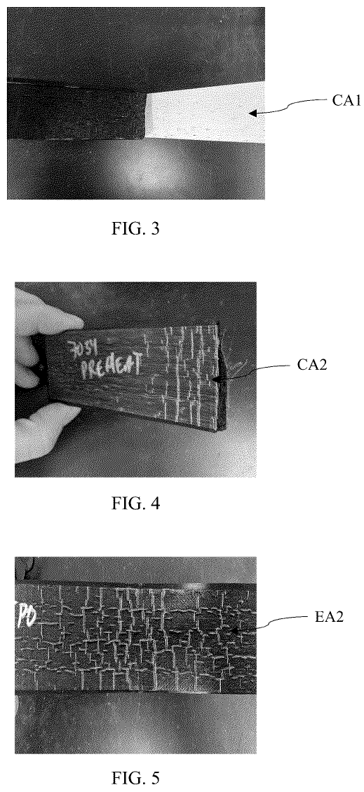

Referring now to FIGS. 1 to 5, Comparative Article CA1, an article including a CFR thermoplastic material having only a polypropylene component and not subjected to preheating, experienced top face delamination when subjected to the three-point flex testing. Comparative Article CA2, an article including a CFR thermoplastic material having only a polypropylene component and subjected to preheating, experienced progressive top face compression buckling starting at 1.3 cm and experienced a bottom tensile break at 2.5 cm. Example Article EA1, an article including a CFR thermoplastic material having a polypropylene component and a polyolefin component and not subjected to preheating, experienced top face compression and progressive top face delamination at 0.64 cm and experienced a bottom face delamination at 4.32 cm. Example Article EA2, an article including a CFR thermoplastic material having a polypropylene component and a polyolefin component and not subjected to preheat treatment, experienced top face progressive compression at 4.47 cm and did not experience a final break. Note that the testing fixture used did not allow for deflection beyond 5 cm. Additionally, as shown in Table 3, Example Articles EA1 and EA2, articles including CFR thermoplastic materials having a polypropylene component and a polyolefin component, had a higher maximum deflection and lower flexural modulus than Comparative Articles CA1 and CA2, articles including CFR thermoplastic materials including only a polypropylene component. As indicated by Comparative Articles CA1 and CA2 and Example Articles EA1 and EA2, CFR thermoplastic materials including a polypropylene component and a polyolefin component result in a softer composition with a similar tensile strength as compared to a similar composition consisting of the polypropylene component and lacking the polyolefin elastomer component. Moreover, articles with sufficient mechanical properties (e.g., tensile strength) may be achieved without preheating.

As also shown in Table 3, Example Articles EA1 and EA2 had a higher maximum load as compared to Comparative Articles CA1 and CA2. As indicated by Comparative Articles CA1 and CA2 and Example Articles EA1 and EA2, although CFR thermoplastic materials including a polypropylene component and a polyolefin component result in a softer composition as compared to a similar composition consisting of the polypropylene component and lacking the polyolefin elastomer component, including these softer compositions results in a relatively stronger over molded article.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A continuous fiber reinforced thermoplastic material, comprising:
a polymer matrix comprising:
a polypropylene component, and
a polyolefin elastomer component; and
50 wt % to 80 wt % of a plurality of continuous fibers, based on a total weight of the continuous fiber reinforced thermoplastic material.

2. The continuous fiber reinforced thermoplastic material of claim 1, wherein the polymer matrix comprises, based on a total weight of the polymer matrix:
20 wt % to 95 wt % of the polypropylene component; and
5 wt % to 80 wt % the polyolefin elastomer component.

3. The continuous fiber reinforced thermoplastic material of claim 1, wherein the plurality of continuous fibers span all or substantially all of a dimension of the continuous fiber reinforced thermoplastic material.

4. The continuous fiber reinforced thermoplastic material of claim 1, wherein each of the continuous fibers in the plurality of continuous fibers have a length and the lengths of the continuous fibers in the plurality of continuous fibers are substantially parallel.

5. The continuous fiber reinforced thermoplastic material of claim 1, wherein the plurality of continuous fibers comprise at least one of glass fibers, aramid fibers, basalt fibers, and carbon fibers.

6. The continuous fiber reinforced thermoplastic material of claim 1, wherein the plurality of continuous fibers have an average diameter from 10 μm to 30 μm.

7. The continuous fiber reinforced thermoplastic material of claim 1, wherein the plurality of continuous fibers have an average linear mass density from 4400 TEX to 276 TEX.

8. The continuous fiber reinforced thermoplastic material of claim 1, wherein the plurality of continuous fibers are in a tow, yarn, roving, or woven mat.

9. The continuous fiber reinforced thermoplastic material of claim 1, wherein the polypropylene component comprises a polypropylene polymer, the polypropylene polymer having has a melt flow index greater than or equal to 15 g/10 minutes, as measured at a temperature of 230° C. at a load of 2.16 kg, a tensile strength greater than or equal to 24 MPa, and a tensile elongation at yield greater than or equal to 2%.

10. The continuous fiber reinforced thermoplastic material of claim 1, wherein the polypropylene component compromises at least one polypropylene polymer selected from the group consisting of polypropylene homopolymer, polypropylene impact copolymer, and polypropylene random copolymer.

11. The continuous fiber reinforced thermoplastic material of claim 1, wherein the polypropylene component comprises a polypropylene polymer that includes at least 85% propylene monomeric units, based on a total of monomeric units in the polypropylene polymer.

12. The continuous fiber reinforced thermoplastic material of claim 1, wherein the polyolefin elastomer component comprises a polyolefin elastomer, the polyolefin elastomer having a melt flow index from 5 g/10 min to 30 g/10 min, as measured at a temperature of 190° C. at a load of 2.16 kg, and a density from 0.83 g/cm³ to 0.91 g/cm³.

13. The continuous fiber reinforced thermoplastic material of claim 1, wherein the polyolefin elastomer component compromises at least one polyolefin elastomer selected from the group consisting of ethylene-butene random copolymer, ethylene-octene random copolymer, and ethylene-octene block copolymer.

14. The continuous fiber reinforced thermoplastic material of claim 1, wherein the continuous fiber reinforced thermoplastic material is a unidirectional tape.

15. The continuous fiber reinforced thermoplastic material of claim 1, wherein the continuous fiber reinforced thermoplastic material is a layer in a laminate.

16. The continuous fiber reinforced thermoplastic material of claim 1, wherein the continuous fiber reinforced thermoplastic material has a tensile strength that is within 20% of the tensile strength of a similar composition consisting of the polypropylene component and the continuous fibers.

17. An over molded article comprising:
the continuous fiber reinforced thermoplastic material of claim 1 bonded to a polymeric substrate.

18. The over molded article of claim 17, where in the polymeric substrate is a fiber reinforced polypropylene substrate.

19. A process for preparing an over molded article comprising:
contacting a continuous fiber reinforced thermoplastic material with a polymeric substrate in a mold; and
applying heat to bond the continuous fiber reinforced thermoplastic material to the polymeric substrate to form an over molded article;
wherein the continuous fiber reinforced thermoplastic material comprises:
a polymer matrix comprising:
a polypropylene component, and
a polyolefin elastomer component; and
50 wt % to 80 wt % of a plurality of continuous fibers, based on a total weight of the continuous fiber reinforced thermoplastic material.

20. The process for preparing an over molded article of claim 19, wherein the continuous fiber reinforced thermoplastic material is not preheated prior to the step of applying heat to bond the continuous fiber reinforced thermoplastic material to the polymeric substrate.

21. The process for preparing an over molded article of claim 19, wherein the mold is an injection mold or a compression mold.
